(19) United States
(12) Patent Application Publication
(10) Pub. No.: US 2005/0178625 A1
(43) Pub. Date: Aug. 18, 2005

(54) Shock absorber

(75) Inventor: Martin Achenbach, Biel (CH)

Correspondence Address: GREER, BURNS & CRAIN, 300 S WACKER DR, 25TH FLOOR, CHICAGO, IL, 60606, US

(73) Assignee: DT Swiss Inc

(21) Appl. No.: 11/010,185

(22) Filed: Dec. 10, 2004

(30) Foreign Application Priority Data
Dec. 12, 2003 (DE) 103 58 355.6

(51) Int. Cl. F16F 9/16

(52) U.S. Cl. 188/302

(57) ABSTRACT

A device for absorbing shocks for two-wheeled vehicles, having at least one chamber filled with a first fluid medium, at least one actuating shaft positioned movably relative to the chamber at least in a first direction and in a second direction substantially opposite the first direction, a partition device positioned movably relative to the chamber which divides the chamber at least into a first subchamber and a second subchamber wherein the partition device is also movable relative to the actuating shaft.

The present invention relates to a device for absorbing shocks. Although the invention is described with reference to bicycles, it should be noted that it can as well be used with other two-wheeled vehicles such as motorbikes, mopeds, motor scooters and the like.

Such absorber devices for bicycles are known from the prior art. Such devices allow to buffer or damp the front wheel or the rear wheel relative to the frame in the case of impacts acting on the wheels such as they occur in rides across bumpy terrain or over the curb.

Such absorber devices use a chamber filled with a liquid medium within which a piston moves such that the medium passes through. For this purpose the piston may be provided with apertures. The cross-sectional area of said apertures allows to regulate the quantity of the medium passing through the piston and thus the absorbing factor.

However, not every riding situation calls for the same absorber response. For example during pedaling the load on the bicycle rear construction varies. In these cases, an absorber response damping the rear construction relative to the frame is not desired to the same degree as for example in rides across rough terrain or over curbs.

It is therefore an object of the present invention to provide an absorber with different absorbing reactions in different riding situations. For example during normal pedaling a certain specified damping should occur and during rides across rough terrain, different damping, for example with a different damping factor and different damping travel. Low amplitude shocks should thus be damped differently, preferably weaker, than high amplitude shocks.

It is a further object of the present invention to provide an absorber device having reduced weight compared to the prior art.

According to the invention a device for absorbing shocks for bicycles comprises at least one chamber filled with a first fluid medium. In addition at least one actuating shaft is provided, positioned movably relative to the chamber at least in a first direction and in a second direction substantially opposite the first direction. The device of the invention further comprises at least one partition means movable in the longitudinal direction of the chamber which partitions the chamber at least into a first subchamber and at least a second subchamber, wherein according to the invention the partition means is also positioned movably between at least a first and at least a second position.

The actuating shaft is preferably the piston rod of the absorber device. It is preferably movable along its longitudinal direction relative to the chamber.

A partition means is understood to mean any means positioned inside the chamber which divides the chamber into at least two subchambers. The partition means may be a wall movable through the chamber, an auxiliary or additional piston or the like. Preferably the partition means is positioned in respect of the actuating shaft such that it is movable in the longitudinal direction of the actuating shaft, meaning in a direction parallel to the direction of movement of the actuating shaft relative to the chamber.

It is not necessary that the partition means divides the chamber to be fluid-tight. Further, the partition means may be both a substantially disk-like element and a unit composed of a number of elements such as for example two disk-like elements positioned substantially parallel relative one another with a substance-free space between them. A piston is also understood to be a partition means in the sense of the present invention.

A preferred embodiment provides for the partition means to be supported on the actuating shaft at least indirectly or in portions. This means that between the partition means and the actuating shaft support means are provided to maintain the partition means movable relative to the actuating shaft, preferably in the longitudinal direction of the actuating shaft.

Another preferred embodiment provides for the partition means to be supported at least indirectly or in portions on an element placed on the first end of the actuating shaft. The first end of the actuating shaft is understood to mean that end extending furthest into the chamber filled with the fluid medium. The second end is understood to mean the end opposite the end of the actuating shaft.

The chamber is preferably the interior of a preferably cylindrical element relative which the actuating shaft moves.

In another preferred embodiment the partition means is supported on a piston means at least indirectly or in portions. This is to be understood such that the device comprises a piston means to which the partition means is movably attached. Preferably the piston means and the partition means are substantially parallel relative one another.

In another preferred embodiment the actuating shaft comprises at least one enlarged region at least in the region of the first end. An enlarged region is understood to mean a region with enlarged cross-section.

In another preferred embodiment at least one biasing element is positioned between at least one portion of the actuating shaft and the partition means. Said biasing element or elastic element may for example be a spring or the like.

Preferably the biasing means biases the partition means relative to the actuating shaft from a second position into a first position. The first position is preferably a position with a maximum distance between the partition means and the second end of the actuating shaft, the second position, a position with a minimum distance between the partition means and the second end of the actuating shaft. The partition means is movable between said second position and the first position relative to the actuating shaft.

In another preferred embodiment the partition means is positioned substantially between an inner and an outer guide area. This means that the partition means is preferably guided by two guide areas.

In another preferred embodiment the partition means is positioned between the first subchamber and the second subchamber so as to be substantially fluid-tight over the whole distance between the first and the second position. Fluid-tight is understood to mean that the fluid is substantially prohibited from passing through the partition means from one to the other subchamber. Therefore the configuration of the partition means is provided to be fluid-tight relative to the chamber, independent of the position of the partition means relative to the actuating shaft.

In another preferred embodiment the partition means comprises at least one bypass in the region between the inner and the outer guide area. Notwithstanding the fluid-tight sealing, a medium can ultimately flow in said bypass between the subchambers through the partition means. Said bypass may be configured such that the medium can pass through in one direction only, or that the flow resistance depends on the flow direction of the fluid through the bypass.

In another preferred embodiment there is at least one fluid connection between the first subchamber and the second subchamber in a central region of the partition means not filled by the partition means. This is to be understood such that the partition means has a hollow space or a chamber devoid of material in its center. This central region further comprises a fluid connection between the first subchamber and the second subchamber. In this embodiment the partition means could thus be in the shape of two disk-like elements substantially parallel relative one another with the mentioned central region being between said elements.

In another preferred embodiment the fluid connection between the first subchamber and the second subchamber is provided inside the actuating shaft at least in portions. In a preferred embodiment the partition means is configured relative to the actuating shaft such that the actuating shaft runs substantially centrally through the partition means.

In another preferred embodiment there is provided between the partition means and the first subchamber, a piston means which is preferably rigidly connected to the actuating shaft and forms a third subchamber together with the partition means. The third subchamber is formed between the piston means and the partition means preferably positioned substantially parallel thereto. Preferably the piston means is rigidly attached relative to the actuating shaft and consequently the partition means is movable relative both the actuating shaft and the piston means.

In another preferred embodiment there is provided between the partition means and the second subchamber, a piston means connected to the actuating shaft forming a third subchamber together with the partition means. In this embodiment the third subchamber is located in the space between the first subchamber and the second subchamber. The difference between the embodiments is in the positioning of the partition means in respect of the piston means. While in the above embodiment the partition means is positioned closer to the first end of the actuating shaft than the piston means, in the last mentioned embodiment the partition means is positioned farther from the first end of the actuating shaft than the piston means.

In another embodiment two partition means could be provided which are positioned movably in respect of the piston means. In this way, a fourth subchamber would be formed as well as a third subchamber. In this way different response reactions to expansion or compression of the absorber device could be achieved.

In another preferred embodiment the piston means terminates substantially fluid-tight with the inside of the chamber. This means that substantially no fluid is allowed to flow past the side of the piston means. This effect is preferably achieved by means of additional means such as O-rings and the like.

In another preferred embodiment the third subchamber is located between the first and the second subchamber at least in portions. In another preferred embodiment the biasing means is located in the third subchamber at least in portions. In this way it is achieved that while the actuating shaft moves relative to the chamber, for example as the third subchamber is compressed so is the biasing means compressed and the biasing means acts against said compression.

In another preferred embodiment a control means is provided that generates a flow resistance that changes as does the flow direction of the medium between the two subchambers. The different flow directions of the medium between the two subchambers are generated by the different movements of the actuating shaft in the first and the second direction of movement. This control means can for example be a configuration of valves, sealing rings or the like which can take different positions depending on the flow direction of the medium so as to generate different flow resistances.

In another preferred embodiment the passage resistance through the central region of the partition means not filled by the partition means is lower than that through the control means in the partition means. This means that the flow resistance is substantially determined by the passage resistance of the control device.

In another preferred embodiment there is positioned between the first subchamber and the second subchamber a valve which can be brought into at least two different positions, wherein at least in a first position of the valve, with a force applied to the piston means, there is substantially no flow of the first medium at least in the first movement direction from the second subchamber into the first subchamber.

In another preferred embodiment the partition means moves in respect of the actuating shaft at least in the first valve position as the piston means applies a force at least in the first direction.

As indicated initially, different response reactions of the absorber device are desired in different riding situations. Thus the valve acts such that normal pedaling of a compression of the absorber device does not result in medium flow through the piston means. This means that during normal pedaling, movement of the piston means in respect of the chamber is restricted. In this case a slight springing of the absorber device is substantially allowed through the movement of the partition means relative to the piston means.

Reversely, however, medium flow can also occur in the first valve position from the first subchamber into the second subchamber. In this way the first valve position, which may be referred to below as the closed position, also allows movement in the direction of expansion of the absorber device. In this way it is guaranteed that during normal pedaling the entire damping travel of the absorber device is also available in the case of sudden severe jolts.

In another preferred embodiment the distance of travel is adjustable over which the partition means can move in respect of the actuating shaft or the piston means.

In another preferred embodiment a fluid medium is provided in the mentioned third subchamber wherein the medium in the third subchamber is preferably the same medium as in the first and the second subchamber.

Another preferred embodiment provides that, at least in the first valve position as the piston means applies a force relative to the chamber, the fluid medium can flow at least in the first direction from the third subchamber into the first subchamber.

In another preferred embodiment there is substantially no flow through the partition means from the second subchamber into the third subchamber when the valve is in the first position. Depending on the positioning of the partition means in respect of the piston means or the actuating shaft it is also possible that substantially no flow occurs through the partition means from the third subchamber into the first subchamber when the valve is in the first position, and vice versa with the piston means applying a force against the chamber, there is flow of the fluid medium at least in the first direction from a second subchamber into the third subchamber.

In another preferred embodiment the valve extends into the partition means at least in portions. In this way the sealing between the partition means and the valve can be guaranteed to be fluid-tight.

In another preferred embodiment there is substantially no flow through the partition means from the second subchamber into the third subchamber independent of the valve position. It is further preferred that in the first valve position, when the piston means moves relative to the chamber in a second direction, the first medium flows from the first subchamber into the second subchamber. It is preferred that as the medium flows from the third subchamber into the first subchamber the flow resistance is lower than the flow resistance as it flows from the first subchamber into the third subchamber. In this way different absorbing reactions to compression or expansion of the absorber device are achieved.

It is preferred that at least one medium path between the first subchamber and the third subchamber is at least in portions identical with at least one path between the first subchamber and the second subchamber. It is preferred that the at least one medium path between the first subchamber and the third subchamber is at least in portions independent of the at least one path between the first subchamber and the second subchamber. This means that preferably the corresponding pathways are in part identical and in part different.

Preferably the valve can be shifted from the first position into the second position by a specified pressure of the first medium at least in one subchamber.

Another preferred embodiment provides in the first valve position when the piston device moves in the second direction relative to the chamber, that medium can flow from the first subchamber into the second subchamber. This means that even when the valve is closed, the absorber can be transferred into a completely expanded state and thus the entire piston travel can be used for damping as bumps occur.

In another preferred embodiment, a specified pressure of the liquid medium can be used to shift the valve from the first position into the second position. This means that below a specified pressure, the valve remains in the closed position and in this closed position the absorber is only allowed limited compression. As soon as the pressure applied to the valve or the piston means exceeds said specified value, the valve opens, allowing a large movement of the piston means in the direction of compression, and the absorber can operate in a wide range.

Pressures below said specified pressure occur for instance by simple pedaling such that in this case the absorber only allows said limited movement in the direction of compression.

It is preferred that as soon as the pressure applied to the valve reaches a specified threshold level, the valve shifts from the first position to the second position. Said specified threshold level is for example reached or exceeded in rides across rough terrain, over rocks and the like. The first valve position is understood to be the closed position and the second valve position, the open position.

Said specified threshold level is preferably adjustable by means of a control means coupled to the valve. For this purpose the actuating shaft includes a hollow space extending axially which functionally connects the master and slave components of the valve means.

The hollow space contains a fluid medium which preferably acts on the valve. There is furthermore provided a master piston, preferably in the end region of the actuating shaft opposite the valve. Due to the position of said master piston the pressure applied to the valve and thus the specified threshold level for shifting the valve from the first position to the second position, can be varied.

For this purpose the control means preferably comprises biasing means for biasing the master piston. Said biasing means may for example be springs which bias the master piston such that a specified pressure of the medium is applied to the valve. As soon as the valve closing force effected by the spring force is overcome by the pressure occurring in the second subchamber the valve opens, allowing a distinct spring deflection.

Thus a hydraulically operated regulating mechanism is proposed for regulating the threshold pressure level at which the valve shifts from the first position to the second position. This hydraulically operated regulating mechanism is reduced in weight compared to mechanically operated devices since force is not transferred for example by means of metal elements but by means of a fluid medium.

It is also preferred to vary the position of the master piston relative to the device and thus also the pressure applied to the valve, by means of an adjusting mechanism. This configuration is advantageous insofar as the rider can readily adjust the specified pressure of the medium for shifting the valve from the first position to the second position without needing accessories such as tire pumps and the like. Adjustment is done via the control equipment which serves for example to change the force which the biasing means applies to the master piston or else the position of the master piston.

Another advantage of the preferred embodiment is that the master component can be freely positioned which, unlike mechanical actuation, does not require substantially axially operating an actuating shaft.

An additional advantage of the preferred embodiment is the freedom obtained in designing and shaping the cover region of the actuating shaft at the end away from the piston which allows a larger pneumatic spring volume while maintaining the construction length.

In another preferred embodiment the path in which the fluid medium passes from the first subchamber through the piston means into the second subchamber is at least in portions different from the path in which the fluid medium passes from the second subchamber through the piston means in the first subchamber. The advantage of this configuration is that independent of open or closed valve positions the piston can expand at all times even though to a limited, adjustable, extent.

It is also conceivable that as the medium passes from one subchamber, for example from the first subchamber into the second subchamber, the medium can travel on one path only whereas as it passes from the second subchamber into the first subchamber it can additionally travel on other pathways. The individual paths may also be selected reversely, meaning that as the medium passes from the second subchamber into the first subchamber, two pathways may be provided whereas as it passes from the first subchamber into the second subchamber only one of the two pathways is available.

In another preferred embodiment a substantially annular seal element is positioned at the valve. This may for example be a disk-like element having a center opening.

In another preferred embodiment the medium is at least in part guided on a rotationally symmetric path as it flows from the second subchamber into the first subchamber. This means that the aperture in the piston means through which the medium is allowed to pass, extends substantially around the entire circumference of the valve means wherein substantially is understood to mean that connecting links and the like may be provided.

In another preferred embodiment a second chamber filled with a second medium is positioned substantially rotationally symmetrically in the first chamber. This means that preferably the outer wall of the first chamber doubles as the inner wall of the second chamber. It is particularly preferred to vary the pressure of the second medium within the second chamber. The second chamber serves for example to guarantee the springing properties of the absorber. The second medium is preferably a gaseous medium and particularly preferred it is air. Said air is fed into a second chamber at a specified pressure wherein pushing the entire absorber means together causes the air to be compressed so as to achieve pneumatic springing.

Instead of air or pneumatic springing other damping or springing mechanisms such as coil springs or the like can be used. The absorber device preferably comprises a valve through which the second chamber can be filled with air.

The first medium is preferably oil or the like, particularly preferred a medium having a higher viscosity than water.

In another preferred embodiment the actuating shaft comprises an outer shaft element and an inner shaft element wherein the inner shaft element can rotate relative to the outer shaft element. It is preferred that rotating the inner shaft element relative to the outer shaft element also causes the inner shaft element to be displaced in longitudinal direction relative to the outer shaft element. For this purpose a thread is provided between the two shaft elements such that rotation results in axial displacement of the inner shaft element relative to the outer shaft element.

Such displacement serves to regulate the quantity of fluid medium, i.e. preferably of oil, that is allowed to pass the piston means as the piston means moves preferably in the direction of expansion.

For this purpose a control means is provided at the end of the shaft element opposite the piston means so as to enable the user to control or regulate the quantity of the oil passing through the piston means by displacing the shaft elements relative one another.

Further advantages and embodiments of the device of the present invention can be taken from the accompanying drawings. These show in:

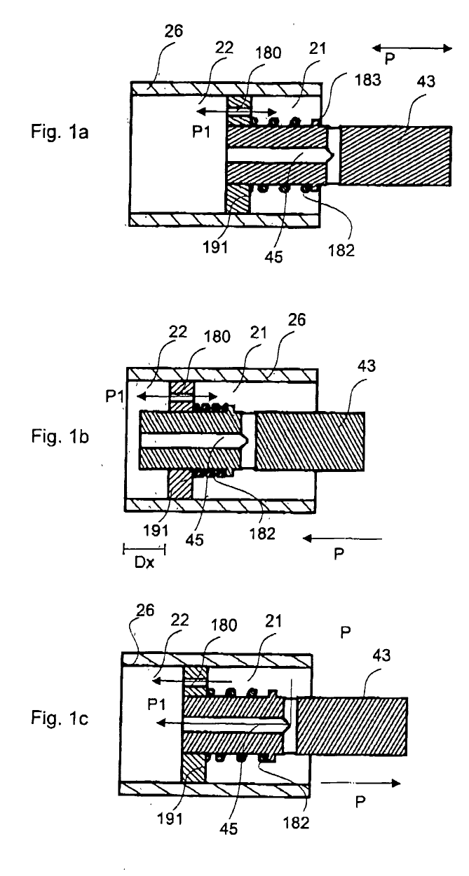

FIG. 1a a schematic illustration of the device of the invention in a first position;

FIG. 1b a schematic illustration of the device of the invention in a second position;

FIG. 1c a schematic illustration of the device of the invention in a third position;

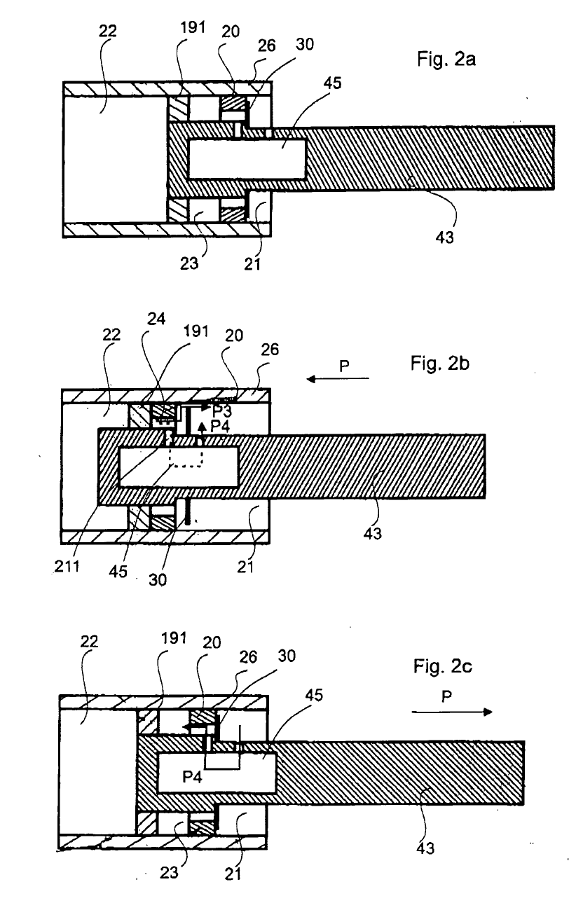

FIG. 2a a schematic illustration of the device of the invention in another embodiment in a first position;

FIG. 2b a schematic illustration of the device of the invention of FIG. 2a in another position;

FIG. 2c a schematic illustration of the device of the invention in FIGS. 2a and 2b in a third position;

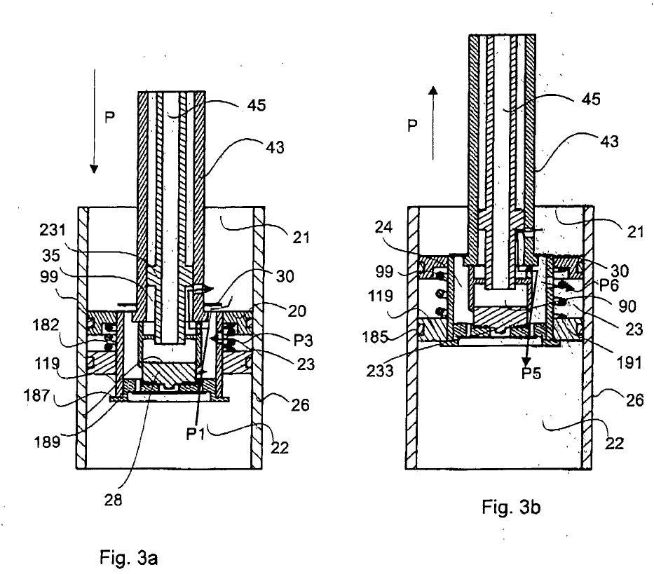

FIG. 3a a detailed illustration of the device of the invention in a first position;

FIG. 3b an illustration of the device of FIG. 3a in another position;

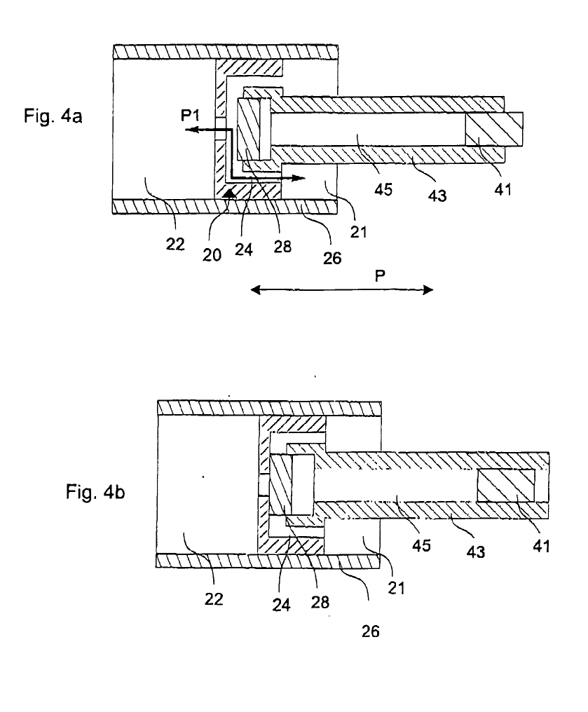

FIG. 4a a schematic illustration for showing the operating principle of the open valve;

FIG. 4b an illustration from FIG. 4a when the valve is closed;

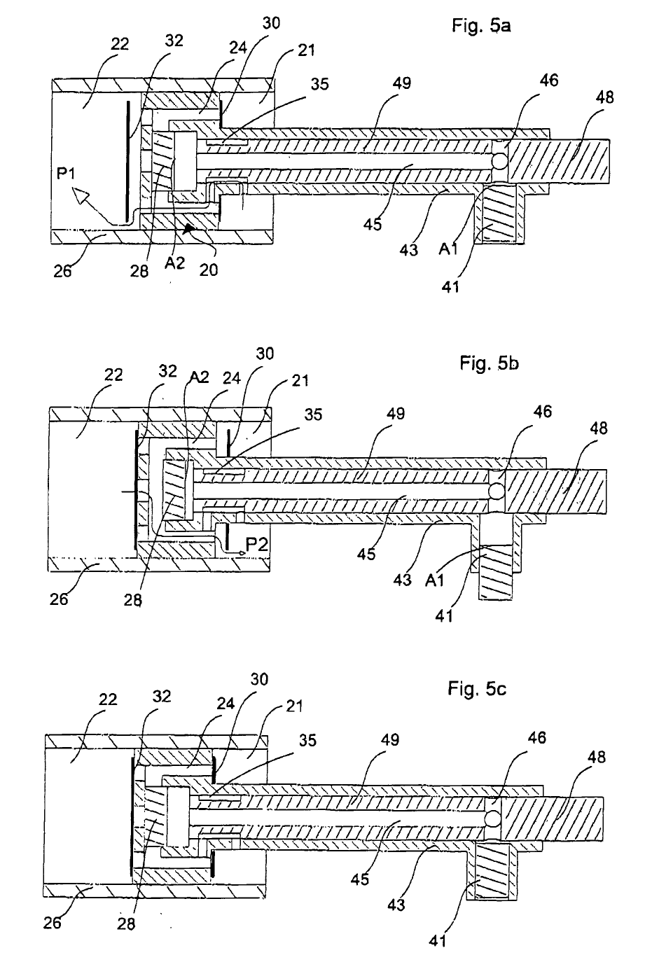

FIG. 5a an illustration showing the operating principle of the valve and the valve control means when the valve is closed;

FIG. 5b another illustration of the device of FIG. 5a when the valve is open;

FIG. 5c another illustration of the device of FIG. 5a when the valve is closed;

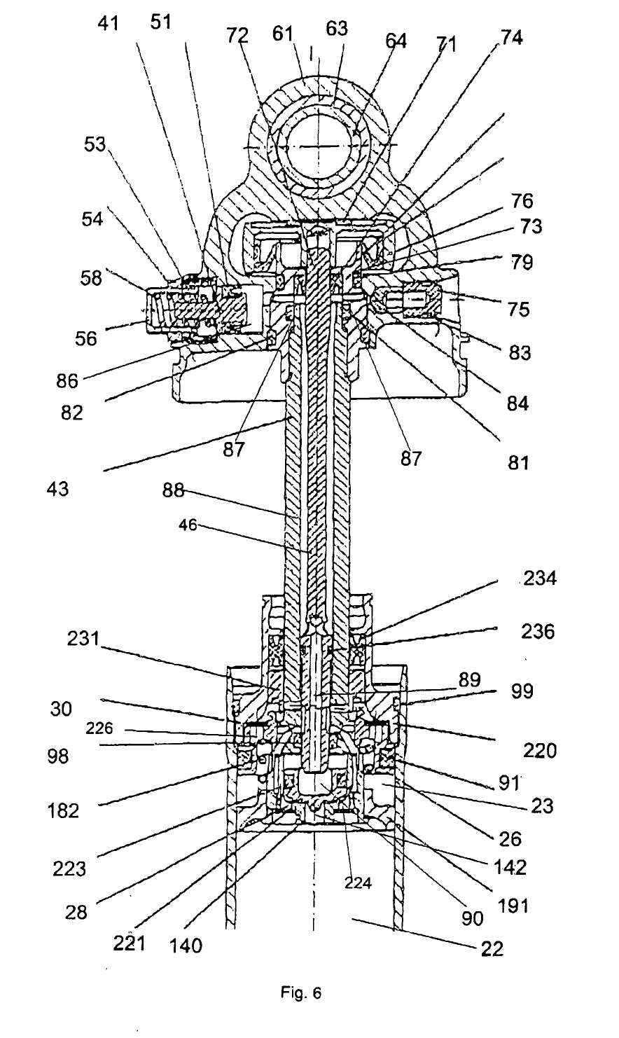

FIG. 6 a sectional view of the device of the invention;

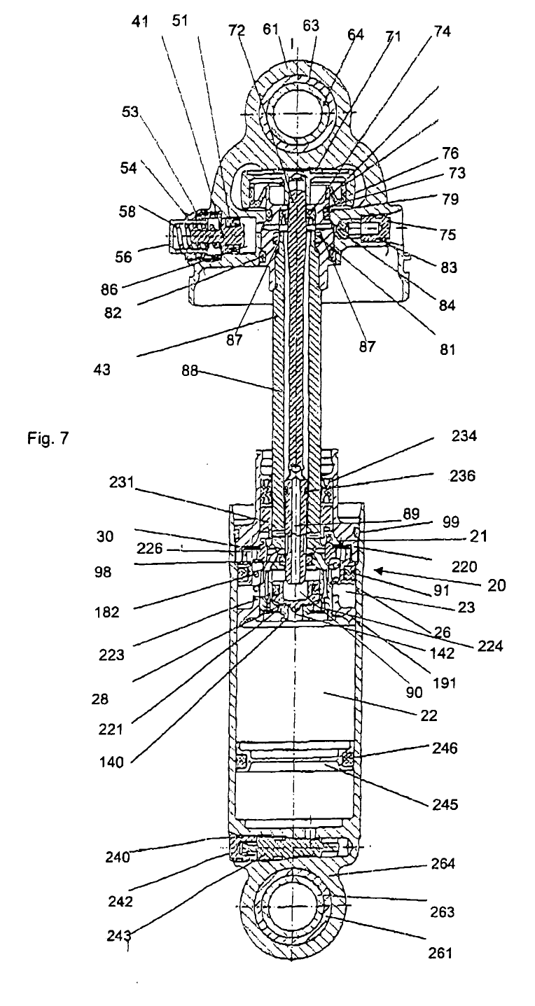

FIG. 7 a total view of the device of the invention;

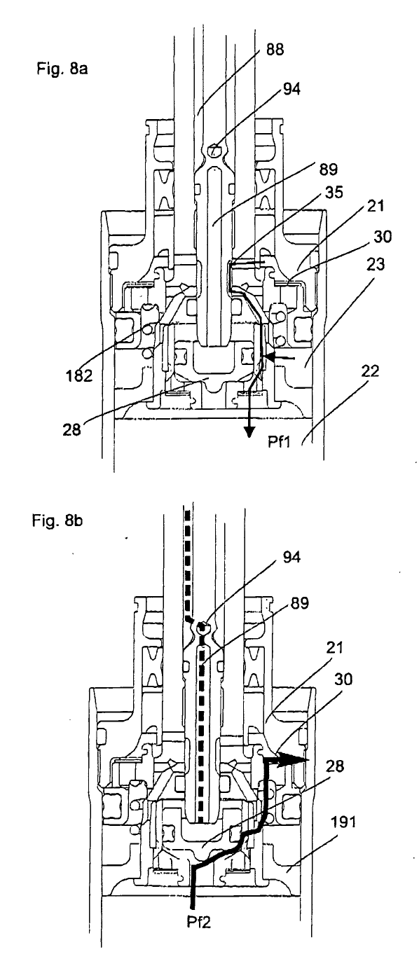

FIG. 8a a cross-sectional view of the piston means when the valve is closed;

FIG. 8b a cross-sectional view of the piston means when the valve is open;

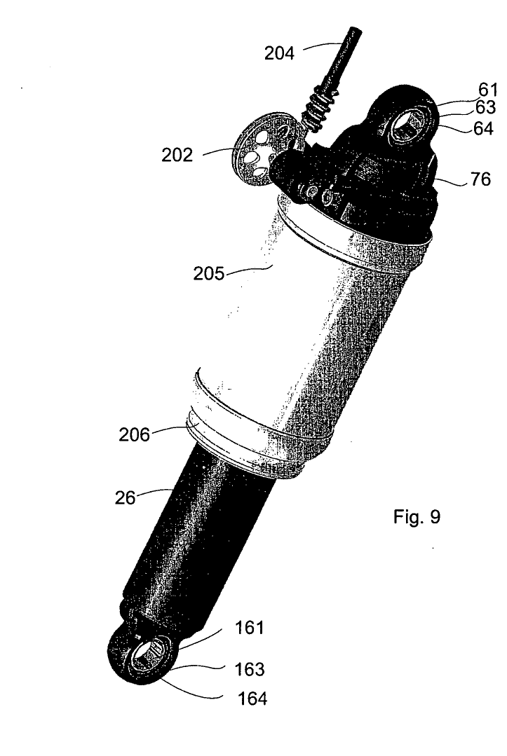

FIG. 9 a total view of the absorber device of the invention;

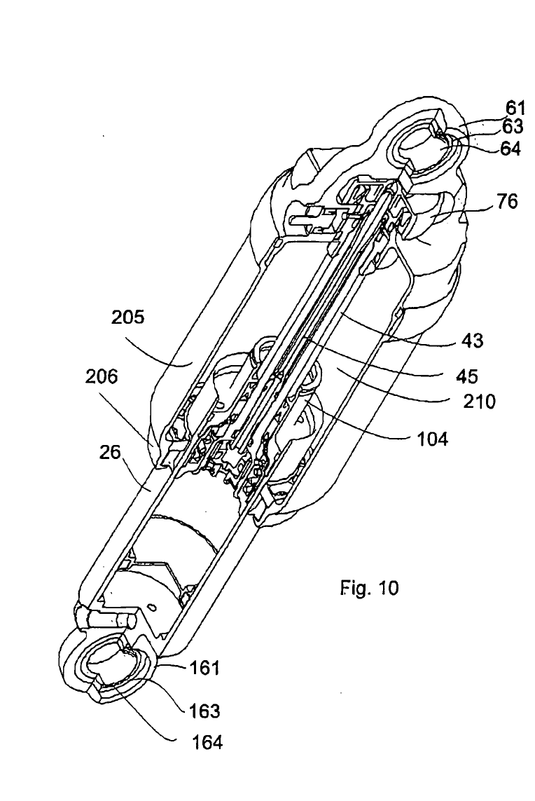

FIG. 10 a partial section of the absorber device of the invention of FIG. 9;

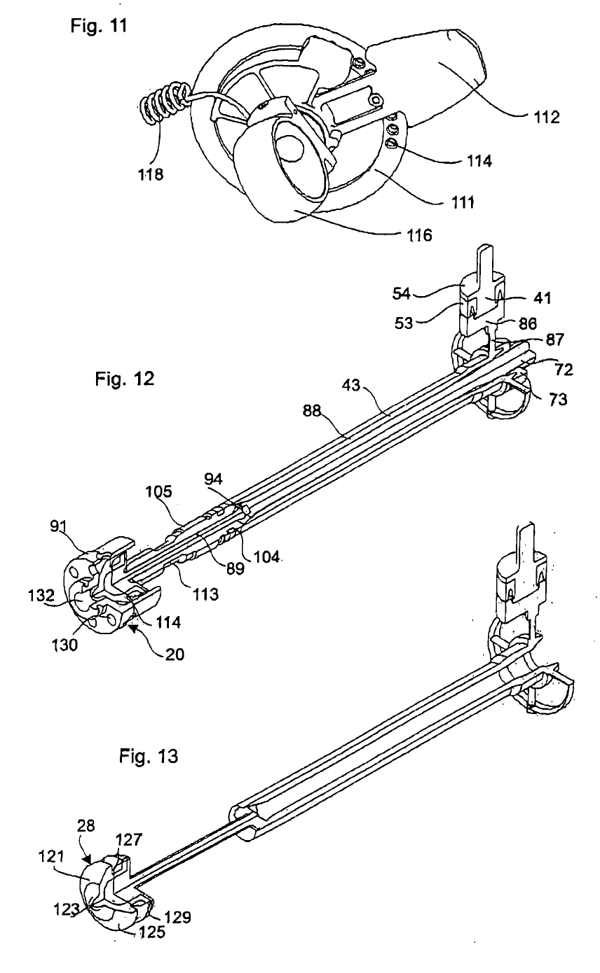

FIG. 11 a control means for the absorber device of the invention;

FIG. 12 an illustration of an actuating shaft for the absorber device of the invention;

FIG. 13 another illustration of the actuating shaft and the valve for the absorber device of the invention;

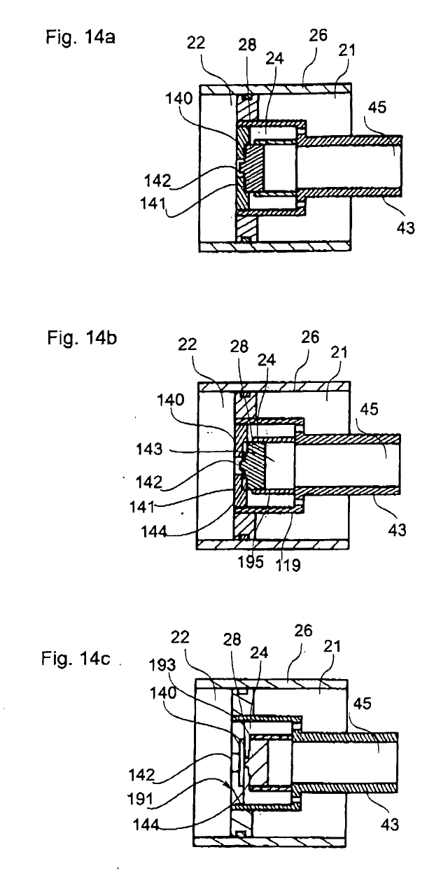

FIG. 14a an illustration of the function of the valve provided with two stepped front faces;

FIG. 14b an illustration of the function of the valve provided with two stepped front faces;

FIG. 14c an illustration of the function of the valve provided with two stepped front faces;

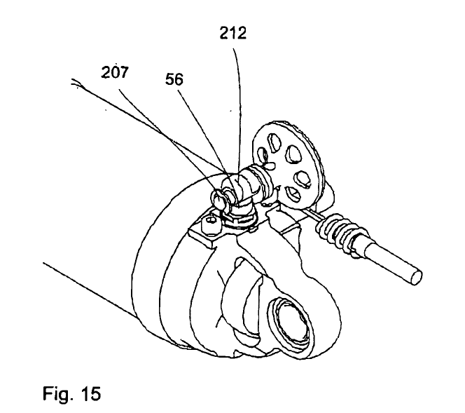

FIG. 15 another total illustration of the absorber device of the invention with the housing of the actuating shaft removed.

FIG. 1a schematically shows a first embodiment of the device of the invention. Reference numeral 43 refers to an actuating shaft moving along the double arrow P relative to the chamber 26. At the first end of the actuating shaft 43 there is positioned a partition means 191 that is movable in the direction of the double arrow P relative to the actuating shaft 43. Said partition means 191 divides the chamber 26 into a first subchamber 21 and a second subchamber 22.

The reference numeral 182 indicates an elastic element supported in the direction of the second end (at the right in FIG. 1a) of the actuating shaft against a projection 183. The second end of the elastic element is supported against the partition means 191. As the actuating shaft moves relative to the chamber 26, the fluid medium can pass along the double arrow P1 through an opening 180 in the partition means 191 from one subchamber into the other subchamber, depending on the direction of movement of the actuating shaft.

Simultaneously, as the actuating shaft 43 moves relative to the chamber 26, the partition means 191 can be displaced relative to the actuating shaft 43 against the spring force of the elastic element 182. This is shown in FIG. 1b. In the situation shown in FIG. 1b the elastic element 182 is in a substantially compressed state. Therefore, as can be taken from the FIGS. 1a and 1b combined, the partition means can be displaced relative to the actuating shaft 43 along the path Dx.

Reference numeral 45 refers to a hollow space positioned inside the actuating shaft 43. As can be seen in FIG. 1c, the fluid can also flow on the path indicated at P1 in the case of expansion of the absorber device illustrated at arrow P in FIG. 1c.

The FIGS. 2a through 2c are a schematic representation of another embodiment of the absorber device of the invention. The absorber device shown in FIGS. 2a through 2c comprises in addition to the actuating shaft 43 and the partition element 191 a piston means 20. Between the piston means 20 and the partition means 191 a third subchamber 23 is formed.

In this embodiment the partition means 191 separates the second subchamber 22 from the third subchamber 23 and the piston means 20, the third subchamber 23 from the first subchamber 21. Reference numeral 180 refers to an opening provided in the piston means 20 through which the fluid from the first subchamber 21 can pass into the third subchamber 23. Preferably a spring means (not shown) or, generally speaking, a biasing element is positioned between the piston means 20 and the partition means 191. Reference numeral 30 refers to a cover device such as for example a shin or the like.

FIG. 2a shows the situation in an idle absorber device. In FIG. 2b the actuating shaft and consequently the piston means rigidly positioned relative to the actuating shaft moves along the arrow P, i.e. to the right in the Figure. Since in this situation the fluid medium cannot flow past the partition means 191, movement of the actuating shaft to the left causes the partition means to move in the direction of the piston means 20. Simultaneously, the medium is forced from the third subchamber into the first subchamber on the path indicated at P4. The medium flows through the horizontal opening 24 and the vertical opening 211 shown in FIG. 2b into the hollow space 45 and from there through the opening 212 into the first subchamber 21. Apart from this, a direct flow through the opening 24 in the direction of the sealing means 30 is also feasible.

FIG. 2c illustrates the situation of a movement of the actuating shaft 43 relative to the chamber 26 to the right, i.e. as the absorber device expands. The sealing means 30 is covering the opening 24 in the piston means 20. In this case the medium is allowed to pass from the subchamber 21 into the subchamber 23 exclusively on the path indicated at P4 through the hollow space 45 inside the actuating shaft.

In this way, two flow paths are provided for compression of the absorber device, for expansion only one, such that varying absorbing reactions are achieved. Preferably the flow path indicated at P4 has a higher flow resistance than the flow path indicated at P3 which leads directly into the first subchamber 21 through the opening 24.

FIG. 3a is a detailed view of the absorber device of the invention which also comprises a valve 28. Above the valve 28 there is provided a fluid in a chamber 90 and in the hollow space 45 positioned inside the actuating shaft 43. Said fluid serves to control, through a control means (not shown), the pressure at which the valve 28 shifts from the closed position shown in the FIGS. 3a and 3b into an open position (not shown). In the open position, the valve 28 would extend farther into the chamber 90 than in the closed position.

As first mentioned, the absorber device of the invention is intended to achieve that for example during normal pedaling the absorbing effect of the absorber device is different from that in rides across rough terrain. The illustrations in FIGS. 3a and 3b show said situation during normal pedaling.

Since the valve 28 is closed, the medium cannot pass from the subchamber 22 into the subchamber 21 within the chamber 26 when the absorber device is compressed. On the other hand though the partition means 191 can move relative to the piston means 20. It is achieved in this way that as the actuating shaft is displaced along the arrow P relative to the chamber 26, the partition means approaches the piston means 20. Said approach counters the spring force of an elastic element 182. In this way, a restricted absorbing effect along a restricted absorbing path is achieved.

Simultaneously the medium from the third subchamber 23 is forced into the first subchamber 21 along the arrow P3. In this case the medium can flow past the sealing means 30. Reference numerals 99 and 185 refer to sealing means which seal the piston means 20 or the partition means 191 from the chamber 26 or the interior wall of the chamber 26. These are preferably O-rings or the like.

Reference numeral 35 indicates a narrowed region inside the actuating shaft 43 constituting a portion of the path P1. Reference numeral 187 indicates an expanded circumferential edge following an enlarged-diameter region 119.

Reference numeral 189 indicates a bottom cover preferably comprising a circumferential opening 189a through which the fluid can pass along the path P1. The function of said cover region will be described in more detail with reference to the FIGS. 14a through 14c.

FIG. 3b shows the situation occurring during expansion of the absorber device, i.e. with movement of the actuating shaft 43 along the arrow P. In this case, the medium flows along arrow P5 from the first subchamber into the third subchamber. The partition means 191 simultaneously moves away from the piston means 20 with this movement being supported by the spring action of the spring element 82. In this case, the medium can simultaneously also flow along arrow P6 from the first subchamber into the third subchamber.

It should be noted at this point that the respective openings in the actuating shaft may also be configured for the medium to flow between the third subchamber 23 and the second subchamber 22.

FIGS. 4a and 4b illustrate the principle of control of the valve 28. Said controlled valve 28 is preferably used in conjunction with the partition means 191 described in FIGS. 1a and 3b.

FIG. 4a is a schematic representation of an absorber device.

Reference numeral 26 indicates an oil chamber in the interior of which a piston means 20 can in principle move in the direction of the double arrow “P”. A piston means 20 serves to divide the chamber formed in the oil chamber 26 into a subchamber 21 on the right and a subchamber 22 on the left.

The devices known from the prior art provide that as the piston means 20 moves to the left relative to the oil chamber 26, a fluid medium provided both in the subchamber 21 and in the subchamber 22 passes from the subchamber 22 through the piston means 20 into the subchamber 21. In the reverse direction, as the piston moves to the right along the arrow, the fluid medium passes from a subchamber 21 into a subchamber 22.

Reference numeral 28 indicates a valve which can be positioned at least in an open position shown in FIG. 1a and a closed position shown in FIG. 1b. When the valve 28 is in the open position shown in FIG. 1a, the medium can pass along the arrow “P1” both from the subchamber 22 on the left into the subchamber 21 on the right and reversely from the subchamber 21 on the right into the subchamber on the left 22.

When the valve 28 is in the closed position shown in 4b, a passage of the fluid medium from the second subchamber (22) into the first subchamber (21) through the piston means 20 is substantially prohibited. In this case movement of the piston means 20 relative to the oil chamber 26 is substantially prohibited.

A control means 41 serves to adjust the position of the valve 28. For this purpose a fluid medium is provided in the hollow space 45 of the actuating shaft 43. A movement of the master piston 41 for example to the left causes the position of the valve 28 to shift towards closed. Reversely, a movement of the master piston 41 to the right causes the position of the valve 28 to shift towards open.

A movement of the piston means 20 to the left results in the medium provided in the subchamber 22 applying a specified force to the valve 28. If that force exceeds the force applied through the medium in the chamber 45, which is adjustable through the master piston 41, the valve 28 opens, allowing medium to flow through in the direction of the arrow “P1”.

While the valve 28 is in the left position shown in FIG. 1b, no medium flows from the subchamber 22 on the left into the subchamber 21 on the right.

FIGS. 5a through 5c show a more detailed illustration of the absorber device of the present invention. FIG. 2a illustrates a situation where when the valve 28 is closed, the absorber device expands, i.e. the piston device 20 moves to the right relative to the oil chamber 26. FIG. 2b illustrates a situation where the valve 28 is open and the absorber device is compressed.

FIG. 5c illustrates the idle position of the absorber or the situation where the pressure rise in the chamber on the compression side is still too low for opening the valve.

Above the piston means a first sealing means 30 is provided which is an annular element covering the end on the right of the passage 24 of the piston means.

Reference numeral 32 indicates a substantially disk-shaped sealing device on the left which, depending on the direction of movement of the piston device 20 relative to the oil chamber 26 either contacts the piston device 20 or is spaced from it.

The arrow “P1” indicates the direction of flow of the medium from the subchamber 21 on the right into the subchamber 22 on the left during expansion of the absorber device. Accordingly the medium flows along a channel 35, then into the connecting channel 24 and finally past the sealing means 32 on the left into the subchamber 22 on the left.

It can be seen that although the valve 28 is closed in FIG. 5a, in the case of the absorber device expanding, i.e. the piston means 20 moving to the right, a medium flow from the subchamber 21 into the subchamber 22 is still possible, meaning that it does not depend on the open or closed position of the valve 28.

FIG. 5c in contrast illustrates the situation where when the valve 28 is closed, compression of the absorber device occurs. In this case the sealing means 32 on the left prohibits a medium flow from the second subchamber 22 into the first subchamber 21. In this way, movement in the direction of compression is substantially prohibited.

FIG. 5b illustrates a situation when the valve is open. In this case the fluid medium can pass through the open center of the sealing means 30 via the channel 24 from the second subchamber 22 into the first subchamber 21. It should be noted that the medium substantially flows through the channel 24 on the illustrated path P2. However, small quantities can also flow through the channel 35 of the piston means from the subchamber 22 on the left into the subchamber 21 on the right.

Preferably the flow cross-section in a portion of the channel 35 is smaller than in channel 24 since it is particularly preferred to achieve a compression stage resistance considerably reduced relative to the rebound stage when the valve is open. The pressure to the rear of the valve 28 can be varied through the master piston 41.

Preferably a biasing means (not shown) is provided which according to FIGS. 5a through 5c applies a specified upward force to the master piston 41. In this way a specified pressure is applied to the piston valve 28. Not before the pressure preset by said biasing means such as a spring is overcome can the valve 28 shift from the closed position into the open position. Said pressure can further be adjusted through the pressure applied to the master piston 41 and thus can the pressure required for shifting the valve 28 from the closed position into the open position.

The biasing means further causes the valve to return from the open position into the closed position when the pressure in the chamber 22 falls below the specified threshold pressure level.

Moreover, the relation of the piston cover surface A1 of the master piston 41 to the valve cover surface A2 serves to achieve a gear ratio step-up or reduction between displacement of the master piston 41 and the resulting changed pressure acting on the valve 28. If for example a small surface A1 and a comparatively large surface A2 is selected, the master piston 41 requires a comparatively small biasing force to effect a change of the specified pressure threshold at the valve 28. Or reversely, if a large surface A1 of the master piston is selected, then a low biasing force acting on the master piston 41 relative to the actuating shaft 43 causes considerable change in the pressures acting on the valve 28.

FIG. 6 is a detailed cross-sectional illustration of the absorber device of the invention. Reference numeral 61 indicates an end surface cover of the absorber device. In a preferred embodiment said cover is at least in portions formed as a sleeve which receives the regulating elements of the absorber device.

Reference numeral 63 refers to a guide ring for a pivot head and reference numeral 64 to a bearing ball in the pivot head. The guide ring and the bearing ball serve to join the absorber device to frame components or other bicycle components. The guide ring 63 and the bearing balls 64 and 164 further ensure that the absorber device is supported to be rotatable about all of its axes relative to the frame component that it is attached to. The guide ring 63 is preferably a component made of reinforced material.

Reference numeral 72 illustrates an inner, extended actuating shaft for regulation. At its upper end region it comprises preferably a polygon end portion that engages with a corresponding aperture in an adjusting knob 76. Turning the adjusting knob 76 rotates the inner actuating shaft 43, displacing it in longitudinal direction. This is the preferred way for regulating the flow cross-section of the pathway where the medium flows from the first subchamber 21 into the second subchamber 22. In this way the rebound damping or the rebound damping factor of the absorber device can be adjusted.

The reference numerals 79, 81, 82 refer to sealing means for preventing fluid medium, i.e. oil, to leak from the device. O-rings are preferably used. Reference numeral 74 refers to a grooved ring positioned opposite the support component 73 for sealing the rotatable inner actuating shaft 43. Reference numeral 78 illustrates a radial shaft seal ring, preferably a lip seal with garter spring, positioned between the control knob and the support component 73.

Reference numeral 75 indicates an end portion of a closing means that serves to feed oil into the regulating means. Said closing means can open and close by means of an adjustment means 84 and it is sealed by means of another sealing ring which is preferably an O-ring, so as to prevent oil leaks from the closed circuit in closed state.

The mode of operation of the regulating means of the valve 28 will now be described.

Reference numeral 41 illustrates the master piston which is biased to the right in the Figure, i.e. in the direction of the actuating shaft 43, by means of biasing means 58 which in the present embodiment is a spring. The adjustment chamber 86 positioned to the right of the master piston 41 contains oil to which more or less pressure can be applied through biasing the spring 58 correspondingly.

The regulating force is adjusted in the present embodiment by axially displacing the end portion 56. In the present embodiment, said end portion 56 is a tappet. Reference numeral 53 indicates a sealing means and reference numeral 54 a retaining ring around the tappet.

The adjustment chamber 86 is in fluid connection with the vertical hollow space 89 in the lower portion of the actuating shaft 43, through the horizontal passage 87 and the vertical passage 88 which is preferably positioned rotationally symmetrically around the actuating shaft 43. In this way the oil can pass into the second adjustment chamber 90 above the valve 28.

By laterally displacing the biasing means 58 relative to the master piston 41, the pressure on the oil can be increased or reduced so as to directly affect the pressure within the adjustment chamber 90. In this way the user can preset the specified pressure at which the valve is to shift from the closed position to the open position.

FIG. 7 is another cross-sectional view of the absorber device of the invention. Reference numeral 245 refers to a piston means positioned in the second subchamber 22. Reference numeral 246 indicates a sealing means for prohibiting medium flow past the side of the piston means 245.

Reference numeral 243 indicates a receiving means for another valve through which the chamber between the piston 245 and beneath the bottom end of the absorber 261 can be filled with compressed gas. The valve is closed by a valve lid 240 and a sealing means prevents leaks of compressed gas from the closed valve.

Reference numeral 182 shows the elastic element positioned between the piston means 20 and the partition means 191. Reference numeral 234 indicates an upper sealing means for sealing the actuating shaft against the chamber 26. Reference numeral 236 indicates a sealing means such as an O-ring for sealing the inner actuating shaft 46 against the actuating shaft 43. Each of the reference numerals 98 and 99 indicate sealing means in the shape of O-rings.

Reference numeral 89 indicates a hollow space where the fluid runs so as to apply pressure to the valve 28, as described above. Reference numeral 220 is a closing chamber against the chamber 26.

Reference numeral 91 indicates a sealing means which in the present embodiment is preferably a quadring.

Reference numeral 221 indicates a sealing means which causes that during compression of the absorber device the fluid cannot pass through the opening 224 from the second subchamber 22 into the third subchamber 23.

Reference numeral 223 indicates a channel through which when the valve 28 is open the fluid can pass from the second subchamber 22 into the third subchamber 23 and ultimately also into the first subchamber 21.

Reference numeral 30 also indicates a sealing means which during expansion of the absorber device prohibits fluid from passing from the first subchamber through an opening 226 into the third subchamber.

Reference numeral 231 indicates a guide sleeve for the actuating shaft.

FIGS. 8a and 8b are detailed views of the piston means to illustrate the flow of the fluid in a compressed (FIG. 5b) and an extended (FIG. 5) absorber device.

When the absorber device is compressed while the valve 28 is in the open position (FIG. 8b), the oil flows on the path indicated at the arrow Pf2. The oil first enters the region beneath the valve in the piston means 20. From there it is diverted to the side or in radial direction past the valve 28, leaves the piston means at the open sealing means 30 and enters into the subchamber 21.

An expansion of the piston device results in the situation shown in FIG. 5a. In the portion 35 the oil flows substantially parallel to the longitudinal direction of the actuating shaft and in this way it passes into the subchamber 3. From there it can continue past the sealing means 221 into the second subchamber 22.

Both pathways Pf1 and Pf2 are rotationally symmetrical with respect to the actuation means. Generally speaking, the path shown at Pf1 is also available when the valve 28 is open while the absorber device is being compressed. However, that path has a smaller flow cross-section than path Pf 2 such that when the valve is open, most of the oil passes along the path Pf 2.

The path Pf 2 is preferably not available while the absorber device is expanding, since this is prevented by the sealing means 30.

The dashed line in FIG. 5b indicates the region where the regulating fluid, i.e. the fluid medium is located which hydraulically operates the valve 28.

FIG. 9 is a total illustration of the absorber device of the invention. There is provided, adjacent to the upper cover means 61 that comprises a guide ring 63 and a bearing ball, also a lower cover means 161 that also comprises a guide ring 163 and a bearing ball 164. The reference numeral 204 refers to a control wire which may for example run to an adjust means positioned at the handlebar. By means of this control wire the user can turn an adjustment knob 202 and thus preset the specified pressure at which the valve 28 shifts from the closed position to the open position.

Reference numeral 205 indicates an outer absorber element which in this embodiment is configured substantially cylindrically and arranged rotationally symmetrically around the oil chamber 26. Compressed gas is fed through a valve (not shown) into the hollow space generated between the oil chamber 26 and the outer absorber element 205. Movement of the oil chamber 26 in one or the other direction relative to the outer absorber element compresses or expands said pneumatic spring resulting in the effect of an air spring.

FIG. 10 is a sectional detailed view of the absorber device of the invention. Reference numeral 210 indicates the third chamber or pneumatic spring, respectively. This chamber is compressed as the absorber means is compressed such as to achieve a springing effect.

FIG. 11 shows an adjust means that attaches for example to the handlebar or other frame elements.

Reference numeral 111 indicates a control knob having a plurality of apertures 114. Said apertures serve as snap-in apertures for engagement with a correspondingly configured pin (not shown) of the shifting means 112. Turning the shifting means relative to the adjust knob operates a control wire (not shown) and thus the adjust means 202 shown in FIG. 4.

FIG. 12 is a detailed view of the actuating shaft with the piston means 20 positioned at the lower end. Displacing the master piston 41 in the direction of double arrow P will, as described above, expand or reduce the adjustment chamber 86. In this way the valve 28 can be shifted from the open to the closed position. As can be taken from the Figure, the adjustment chamber 86 is in fluid connection with the valve 28 through a horizontal connection 87, the vertical connection 88 and the second vertical connection 89. The oil flows in the intermediate region 94 from the vertical connection 88 into the vertical connection 89.

Reference numeral 105 indicates a thread which causes the actuating shaft 43 to be displaced lengthwise as it is rotated. Reference numeral 95 indicates the end portion of the piston means 20. It comprises a plurality of apertures 130 positioned around a center opening 132.

The piston means 20 further comprises a wall section 114 extending inwardly substantially annularly which extends annularly around the valve 28 in FIG. 10. Reference numeral 91 refers to a sealing means to prohibit oil flowing in an exchange between control fluid and absorber fluid. Preferably said means is a quadring.

The actuating shaft 43 has a larger diameter region 119 and a smaller diameter region 113 in its longitudinal direction. The smaller diameter region 113 preferably serves as an oil flow path as the absorber device expands.

FIG. 13 is another detailed illustration of the valve 28 of the invention. It comprises a lower sealing element 125 comprising a central projection 123. Said projection extends into the center opening 132 in the closed position, preferably without closing it. The basic valve shape is substantially cylindrical, i.e. the valve diameter is constant around its longitudinal axis, interrupted only by the sealing ring recess.

The shape of the projection 123 preferably serves to optimize control of the flow direction of the medium. The projection is preferably not intended to have a sealing function.

FIG. 14a shows the valve cross-section of the particularly preferred embodiment in a first, closed position.

The first end face 140 contacts the inside 141 of an upper closing means of the valve chamber which may for example comprise the piston means 20.

Thus the cross-section acting on the valve which the oil in the second subchamber applies pressure to, substantially corresponds to the cross-section of the flow passage 142 in the upper closing means of the valve chamber.

FIG. 14b shows the situation as the force generated by the oil pressure in the first subchamber in conjunction with the cross-section mentioned above, exceeds the counterforce which is substantially generated by the oil pressure in the control circuit 143 in conjunction with the effective valve cross-section.

As soon as the first end face 140 lifts off the inside 141 of the closing means, the oil from the first subchamber can also apply pressure to the second end face 143 which allows the valve to open particularly fast.

FIG. 14c illustrates the fully open valve.

FIG. 15 illustrates the absorber with optional remote control, with the shaft housing cut away.

The cam joined to the shaft actuates the tappet 56 which loads the spring 58 through axial displacement.

In a preferred embodiment the shaft and the cam contour are configured integrally.

In another preferred embodiment the fluid connection 86, 87, 88, 89 between master piston 41 and valve 28 comprises a control device (not shown) which has different passage resistances in the two directions of movement.

As a result of this the valve shifts to the closed position at a lower speed than that with which the force of the spring 58 acts on the master piston 41.

1. A device for absorbing shocks for two-wheeled vehicles, having at least one chamber filled with a first fluid medium;
at least one actuating shaft positioned movably relative to the chamber at least in a first direction and in a second direction substantially opposite the first direction;
a partition means positioned movably relative to the chamber which divides the chamber at least into a first subchamber and a second subchamber wherein the partition means is also movable relative to the actuating shaft.

2. The device of claim 1, wherein the partition means is at least indirectly supported on the actuating shaft.

3. The device of claim 1, wherein the partition means is supported at least in portions on an element attached to a first end of the actuating shaft.

4. The device of claim 1, wherein the partition means is at least indirectly supported on a piston means.

5. The device of claim 1, wherein the actuating shaft comprises at least one enlarged region at least in the region of the first end.

6. The device of claim 1, wherein at least one elastic element is positioned between at least one portion of the actuating shaft and the partition means.

7. The device of claim 1, wherein at least one biasing means biases the partition means from a second to a first position.

8. The device of claim 1, wherein the partition means is positioned so as to be substantially fluid-tight between an inner and an outer guide area.

9. The device of claim 7, wherein the partition means is positioned between the first subchamber and the second subchamber so as to be substantially fluid-tight over the whole distance between the first and the second position.

10. The device of claim 8, wherein the partition means comprises at least one bypass running substantially parallel to the actuating shaft in the region between the inner and the outer guide area.

11. The device of claim 1, wherein there is at least one fluid connection between the first subchamber and the second subchamber in a region of the partition means not filled by the partition means.

12. The device of claim 11, wherein the connection runs inside the actuating shaft at least in portions.

13. The device of claim 1, wherein there is provided between the partition means and the first subchamber, a piston means which is connected to the actuating shaft and forms a subchamber together with the partition means.

14. The device of claim 1, wherein there is provided between the partition means and the second subchamber, a piston means which is connected to the piston shaft and forms a third subchamber together with the movable element.

15. The device of claim 13, wherein the piston means terminates substantially fluid-tight with the inside of the chamber.

16. The device of claim 14, wherein the third subchamber is located between the first and the second subchamber at least in portions.

17. The device of claim 14, wherein the biasing means is located in the third subchamber at least in portions.

18. The device of claim 1, wherein between the inner and the outer guide area of the partition means between the first and the second subchamber there is a control device in a bypass.

19. The device of claim 1, wherein the control means comprises varying flow resistance depending on the flow direction of the medium between the two subchambers.

20. The device of claim 18, wherein the passage resistance through the central region of the movable element not filled by the partition means is lower than that through the control means in the partition means.

21. The device of claim 1, wherein at least one valve is positioned between the first subchamber and the second subchamber which can be brought into at least two different positions, wherein at least in one first valve position with a force applied to the piston means there is substantially no flow of the first medium at least in the first direction of movement from the first subchamber into the second subchamber.

22. The device of claim 14, wherein the partition means moves in respect of the actuating shaft at least in the first valve position as the piston means applies a force at least in the first direction.

23. The device of claim 1, wherein the distance of travel is adjustable by which the partition means can move in respect of the actuating shaft.

24. The device of claim 14, wherein a fluid medium is provided in the third subchamber.

25. The device according to claim 24, wherein the medium in the third subchamber is the same medium as in the first subchamber and the second subchamber.

26. The device of claim 14, wherein at least in the first valve position as the piston means applies a force relative to the chamber the fluid medium can flow at least in the first direction from the third subchamber into the first subchamber.

27. The device of claim 14, wherein there is substantially no flow through the partition means from the second subchamber into the third subchamber when the valve is in the first position.

28. The device of claim 14, wherein the first position of the valve, with the piston means moving against the chamber in the second direction the first medium flows from the first subchamber into the second and/or the third subchamber.

29. The device of claim 14, wherein the flow resistance at medium flow from the third subchamber into the first subchamber is lower than the flow resistance at flow from the first subchamber into the third subchamber.

30. The device of claim 1, wherein the valve can shift from the first position into the second position by a specified pressure of the first medium at least in one subchamber.

31. The device of claim 1, wherein the path on which the first medium passes from the first subchamber through the piston means into the second subchamber is at least in portions different from the path on which the first medium passes from the second subchamber through the piston means into the first subchamber.
